(19) United States
(12) Patent Application Publication
(10) Pub. No.: US 2008/0245003 A1
(43) Pub. Date: Oct. 9, 2008

(54) HURRICANE DOOR LITE ASSEMBLY, DOOR, AND RELATED METHODS

(76) Inventors: Richard Henry KON, Cornelius, NC (US); Gary Thomas Fagan, Huntersville, NC (US); Matthew Donald White, Charlotte, NC (US)

Correspondence Address: BERENATO, WHITE & STAVISH, LLC, 6550 ROCK SPRING DRIVE, SUITE 240, BETHESDA, MD, 20817, US

(21) Appl. No.: 12/025,858

(22) Filed: Feb. 5, 2008

Related U.S. Application Data
(60) Provisional application No. 60/899,650, filed on Feb. 6, 2007.
(60) Provisional application No. 60/924,540, filed on May 18, 2007.
(60) Provisional application No. 60/935,446, filed on Aug. 14, 2007.

(51) Int. Cl. E06B 1/04

(52) U.S. Cl. 52/208; 49/506

(57) ABSTRACT

Provided is a door lite assembled with an associated frame, and a door designed to meet certain building codes and standards which were promulgated with the intent to provide protection against the effects of certain hurricane force winds, as well as related methods of making such invention. The door lite assembly includes a translucent panel, a high-impact plastic frame, and a chemical sealant. The frame extends along the periphery of the translucent panel and includes panel support portions having panel support lips facing the opposite sides of the translucent panel. The frame further includes door receiving portions having door body receiving lips spaced apart from one another to permit receipt of a door body. The chemical sealant is applied to establish a weather-tight seal between the panel supporting lips and the translucent panel, wherein the high-impact plastic frame, translucent panel and the sealant establish a structure capable of withstanding the effects of certain hurricane conditions as measured by successful passing of Testing Application Standard 201-94 (TAS 201) based on a missile velocity of 35 miles per hour and Testing Application Standard 203-94 (TAS 203) based on a 9000-cycle regime applied consecutively.

### CROSS REFERENCE TO RELATED APPLICATION

This application claims the benefit of priority of provisional applications bearing Ser. No. 60/899,650 filed Feb. 6, 2007, Ser. No. 60/924,540 filed May 18, 2007, and Ser. No. 60/935,446 filed Aug. 14, 2007, the complete disclosures of which are incorporated herein by reference.

### FIELD OF THE INVENTION

The invention relates to an impact-resistant assembly featuring a door lite and associated frame members designed to meet certain building codes and standards which were promulgated with the intent to provide protection against the effects of certain high winds, particularly hurricane-force winds. The invention also relates to a door containing the impact-resistant assembly, and to a method of making an impact-resistant door lite assembly and the resulting door.

### BACKGROUND OF THE INVENTION

The prior art includes multiple designs and configurations of door lites and associated frames. In the past, the prevailing design considerations for most commercially available door lites have been appearance and basic fit with the associated door. However, in addition to its aesthetic role, the door lite constitutes an important part of the protective barrier between the exterior and the interior of a house or other residential, commercial, or industrial building.

In the event of a severe storm or a hurricane, the atmospheric pressure inside a building (e.g., house, dwelling, etc.) is much greater than the pressure outside the building. If a breach occurs in the protective barrier of the building, the pressure within the building seeks to immediately equalize with the pressure outside the building, resulting in an explosive reaction that may cause severe structural damage to the building, and leave the building interior exposed and vulnerable to further damage. Because conventional door lites are relatively easily broken or breached by flying debris, storm damage associated with conventional door lites is relatively common and costly.

The damage imparted by severe storms and hurricanes has prompted officials and insurance companies to establish standards, especially in coastal areas, that apply to “glazed units”, including door lites. The standards are designed to ensure door lites possess structural properties sufficient to withstand the effects of high winds. The Testing Application Standard 201-94 (TAS 201) test is designed to test a product's resistance to windborne debris. To pass the test, the glazed panel must withstand a Large Missile Impact test. The missile used in the test is a 9 pound, 7-9 foot Southern Yellow Pine 2×4. The missile is placed 17 feet from the tested unit, and launched so that the missile attains a speed of 35 miles per hour (50 feet/second) immediately before/upon impacting the target face of the glazed panel, as specified in Florida Building Code, Building (2004), Section 1626.2.4.

After the TAS 201 test is performed, a TAS 203-94 (TAS 203) test is carried out. The same glazed panel is used for the TAS 201 test and the TAS 203 test. The TAS 203 test is designed to evaluate the resistance of the product to cyclic pressure differentials that may occur when a hurricane passes. The pressure is applied to a first side of the glazed panel at varying cycle pressures. Next, a vacuum is applied to the same side. The cycling of pressure and vacuum is continued on the glazed unit during the TAS-203 test, as applied in the Florida Building Code, Building (2004) Section 1626, Table 16.26, for a total of 9000 wind pressure cycles, i.e., 4500 positive wind pressure cycles, 4500 negative wind pressure cycles. The above TAS tests and Florida Building Code sections are incorporated herein by reference.

Currently available door lites present various assembly and performance issues. For example, certain door lites possess screw holes which must be aligned with corresponding screw holes of a surrounding door lite frame in order to assemble the door. This alignment step can be laborious and can hold up production. Other door lites require the extrusion or shaping of expensive metallic materials. As a result, many of the currently available hurricane door lites are relatively expensive and/or difficult to manufacture and install. It has been proposed to prepare door lites from non-metallic material frames, but such proposed designs have the drawback of a bulky and aesthetically unattractive appearance.

The need exists for a hurricane door lite that passes the TAS 201 and TAS 203 tests, is relatively easy to manufacture and install, and is aesthetically attractive.

### SUMMARY OF THE INVENTION

According to a first aspect of the invention, a door lite assembly is provided featuring a translucent panel having a periphery and opposite first and second sides, a high-impact plastic frame extending along the periphery of the translucent panel, and a chemical sealant. The frame includes first and second panel support portions having first and second panel support lips facing the first and second sides of the translucent panel, respectively, and first and second door receiving portions having first and second door body receiving lips, respectively, spaced apart from one another to permit receipt of a door body between the first and second door body receiving lips. The chemical sealant is applied to establish a water-proof seal between the first and second panel supporting lips and the translucent panel. The high-impact plastic frame, translucent panel, and the sealant establish a structure capable of withstanding the effects of certain hurricane force winds as measured by successful passing of Testing Application Standard 201-94 (TAS 201) based on a missile velocity of 35 miles per hour and Testing Application Standard 203-94 (TAS 203) based on a 9000-cycle regime applied consecutively.

A second aspect of the invention provides a door, including a door body having first and second sides and an opening, a translucent panel situated in the opening, a high-impact plastic frame extending along the periphery of the translucent panel, and a chemical sealant. The frame includes first and second panel support portions having first and second panel support lips facing the first and second sides of the translucent panel, respectively, and first and second door receiving portions having first and second door body receiving lips facing the first and second sides of the door body, respectively. The chemical sealant is applied to establish a water-proof seal between the first and second panel supporting lips and the translucent panel, and to establish a water-proof seal between the first and second body receiving lips and the door body. The door body, translucent panel, high-impact plastic frame and the sealant establish a structure capable of withstanding the effects of certain hurricane force winds as measured by successful passing of Testing Application Standard 201-94 (TAS 201) based on a missile velocity of 35 miles per hour and Testing Application Standard 203-94 (TAS 203) based on a 9000-cycle period regime consecutively.

According to a third aspect of the invention, a method is provided for making a door lite assembly. The method features applying a high-impact plastic frame to a translucent panel so as to extend along the periphery of the translucent panel. The frame includes first and second panel support portions having first and second panel support lips facing the first and second sides of the translucent panel, respectively, and first and second door receiving portions having first and second door body receiving lips, respectively, spaced apart from one another to permit receipt of a door body between the first and second door body receiving lips. A chemical sealant is then applied to establish a water-proof seal between the first and second panel supporting lips and the translucent panel. The high-impact plastic frame, translucent panel, and the sealant establish a structure capable of withstanding the effects of certain hurricane force winds as measured by successful passing of Testing Application Standard 201-94 (TAS 201) based on a missile velocity of 35 miles per hour and Testing Application Standard 203-94 (TAS 203) based on a 9000-cycle regime applied consecutively.

A fourth aspect of the invention provides a method of making a door. A translucent panel is situated into the opening of a door body, and a high impact plastic frame is applied to extend along the periphery of the translucent panel and to interconnect the translucent panel to the door body. The frame includes first and second panel support portions having first and second panel support lips facing the first and second sides of the translucent panel, respectively, and first and second door receiving portions having first and second door body receiving lips facing the first and second sides of the door body, respectively. A chemical seal establishes a first water-proof seal between the first and second panel supporting lips and the translucent panel, and establishes a second water-proof seal between the first and second body receiving lips and the door body, wherein the door body, translucent panel, high-impact plastic frame and the sealant establish a structure capable of withstanding the effects of certain hurricane force winds as measured by successful passing of Testing Application Standard 201-94 (TAS 201) based on a missile velocity of 35 miles per hour and Testing Application Standard 203-94 (TAS 203) based on a 9000-cycle regime applied consecutively.

The above-described aspects of the invention may be implemented to prepare the frame from a blend containing polycarbonate and an acrylonitrile-styrene-acrylate terpolymer, although other polymers and polymer blends may be used.

The above-described aspects of the invention also may implemented to provide a organo-siloxane as the chemical sealant, although other sealants may be used.

According to another implementation of the above-described aspects of the invention, the high-impact plastic frame includes a first frame member, a second frame member, and a connector securing the first and second frame members together, the first frame member having the first panel support portion and the first door receiving portion, the second frame member having the second panel support portion and the second door receiving portion.

Additional aspects of the invention will become more apparent upon viewing the accompanying drawings and considering the detailed description of exemplary embodiments and methods of the invention.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 is a plan view of a door according to a first embodiment of the invention;

FIG. 2 is an exploded assembly drawing of the door of FIG. 1 according to the first embodiment of the present invention;

FIG. 3 is a fragmentary cross-sectional view taken along the line 3-3 of FIG. 1;

FIG. 4 is a cross-sectional end view of frame members joined together with a frame connector according to the first embodiment of the present invention;

FIG. 5 is a fragmentary, perspective, cross-sectional view of the frame members of FIG. 4 joined together with the frame connector;

FIG. 6 is a plan view of a door according to a second embodiment of the invention;

FIG. 7 is a cross-sectional end view taken along line 7-7 of FIG. 6 of frame members joined together with a frame connector according to the second embodiment of the present invention;

FIG. 8A is a plan view of door skin according to an embodiment of the present invention including an opening possessing a semielliptical configuration;

FIG. 8B is a plan view of a door skin according to an embodiment of the present invention including an opening possessing an elliptical configuration;

FIG. 8C is a plan view of a door skin according to an embodiment of the present invention including an opening having a configuration having a semielliptical portion and an integrated rectangular portion; and

FIG. 9 is another cross-sectional end view of frame members joined together with a frame connector according to the first embodiment of the present invention.

### DETAILED DESCRIPTION OF PREFERRED EMBODIMENTS AND PREFERRED METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

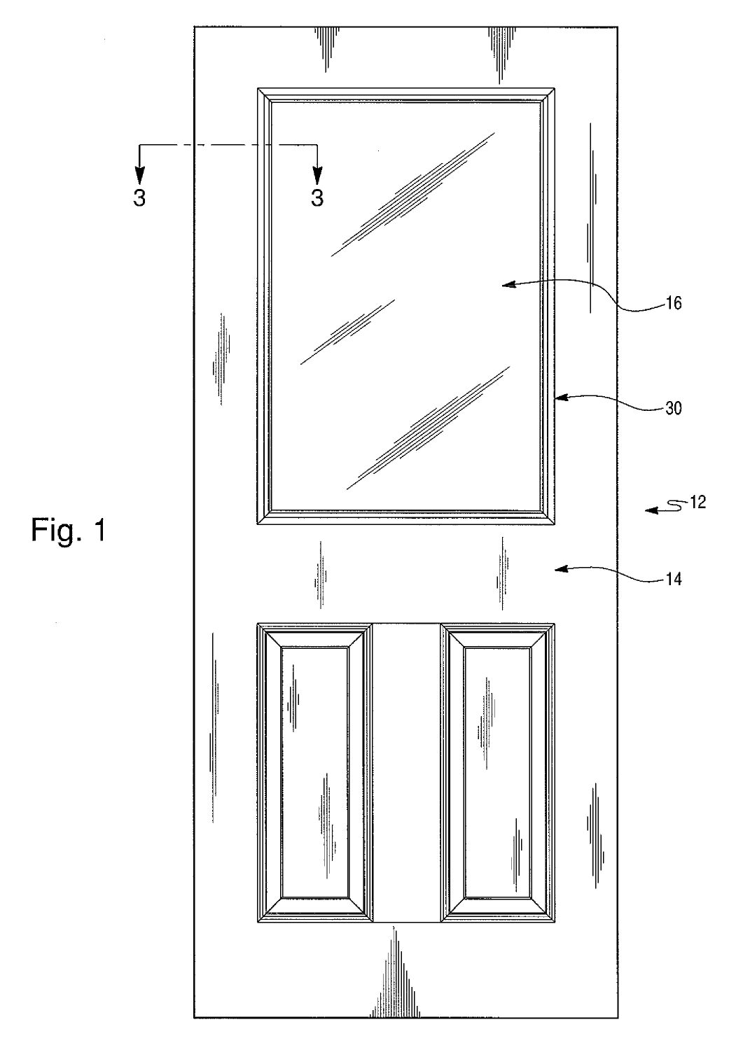

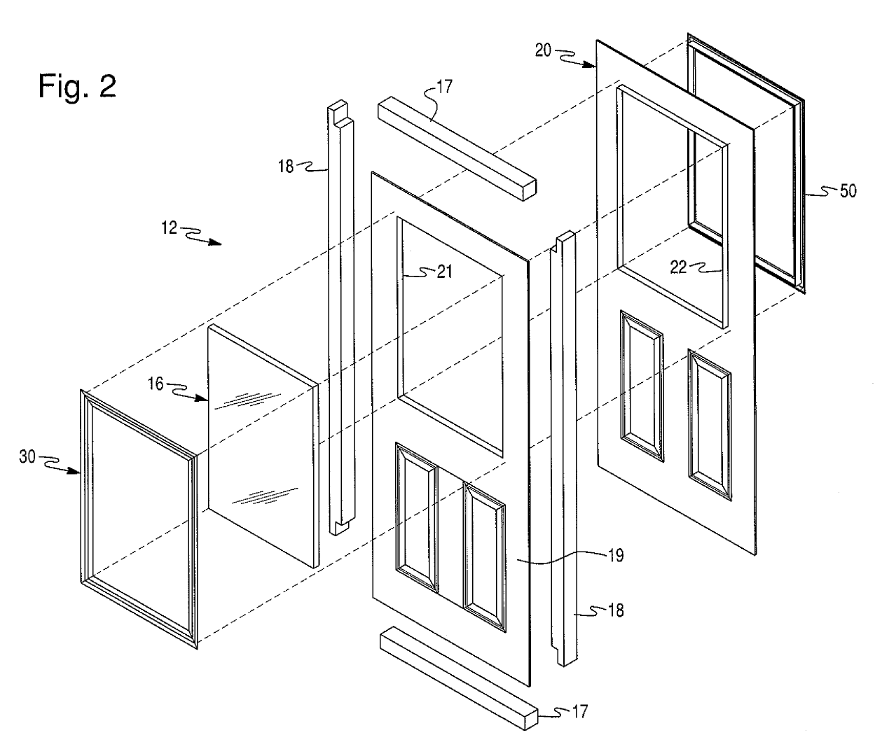

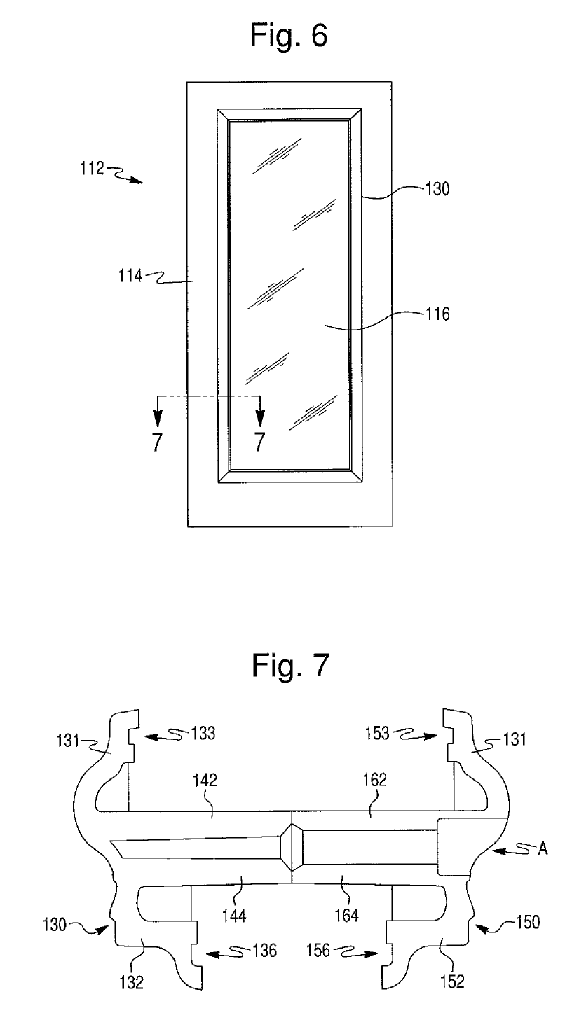

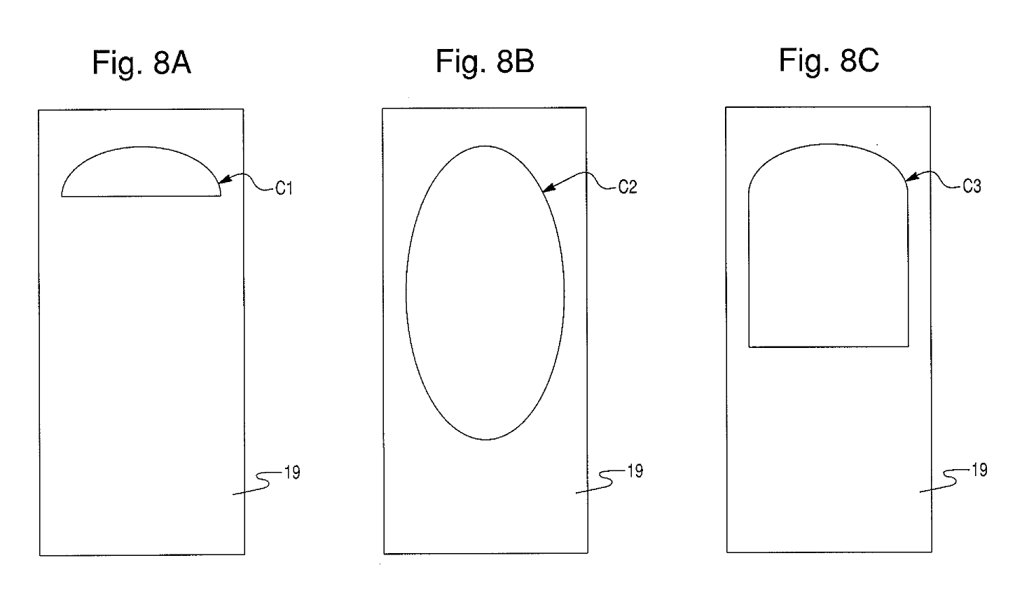

Referring now more particularly to the illustrated embodiments, FIGS. 1 and 2 illustrate a door according to a first embodiment of the present invention indicated generally by reference numeral 12. The door 12 includes a door body 14 provided with an opening for receiving a translucent panel 16, such as impact-rated glass. First and second frame members 30, 50 (FIG. 2) interconnect the door body 14 to the translucent panel 16. The door 12 may be for residential, business, or industrial use. Although illustrated as a main exterior door with a panel design, it should be understood that the door 12 may contain no panels, i.e., a flush door. Further, the door 12 may comprise a patio door, such as door 112 shown in FIG. 6.

As best illustrated in detail in FIG. 2, the door body 14 includes first and second door skins (also known as door facings) 19 and 20, respectively, top and bottom rails 17, and left and right stiles 18. The first and second door skins 19 and 20 are secured to each other on opposite sides of the top and bottom rails 17 and the left and right stiles 18, which rails and stiles collectively establish a frame. Typically, adhesive is used to secure the door skins 19, 20 to the door frame. In the case of metallic (e.g., steel) door skins 19, 20, mechanical fastening and the like, for example, may be used. Referring now to FIG. 3, the first and second door skins 19, 20 are secured to each other so as to form a cavity therebetween. The cavity of the door 12 optionally is filled with an expanded foam insulating material 28 defining an insulating core of the door 12. Other core materials may also be used.

Preferably, the first and second door skins 19 and 20 are molded from an appropriate polymer material and have a thickness oft, for example, about 1 mm to about 4 mm. The selected material of the door skins 19 and 20 can be sheet molding compound (SMC) with reinforcement (e.g., fiber glass, cellulosic material), metal (e.g., steel), wood, medium density fiberboard, high density fiberboard, or other materials suitable for the contemplated use. The skins 19, 20 may be made of the same or different materials. Preferably, the door skins 19 and 20 are molded and can be made from such materials as fiberglass reinforced plastics, pressed board, thermosetting compounds (e.g., vinyl esters), thermoplastics (e.g., polypropylene, polystyrenes), cellulosic material and resin composites, or other moldable materials. The outer surfaces of the door skins 19, 20 can be smooth or can have a simulated wood grain. The depth of the wood grain optionally is about 0.05 mm to about 0.2 mm. An inner surface of the door skins 19, 20 may have a relatively rough or textured surface to increase the surface area for adhesive when the door 12 is assembled. The roughened inner surface may provide stronger bonds between the door skins 19, 20, the foam material 28, the rails 17, and the stiles 18.

The first and second door skins 19 and 20 are each provided with respective openings 21, 22 therethrough for receiving the translucent panel (e.g., door lite) 16. While the openings 21, 22 are shown in FIGS. 1 and 2 as possessing a rectangular shape, they can have any configuration, provided that the openings are complementary. For example, first and second door skins 19, 20 may be provided which include openings 21, 22 possessing a semielliptical configuration C1, as shown in FIG. 8A (showing door skin 19). Or, first and second door skins 19, 20 may be provided which include openings 21, 22 possessing an elliptical configuration C2, as shown in FIG. 8B (showing door skin 19). Or, first and second door skins 19, 20 may be provided which include openings 21, 22 possessing a configuration having a semielliptical portion and an integrated rectangular portion C3, as shown in FIG. 8C (showing door skin 19). Thus, it would be apparent to one skilled in the art that other configurations may be provided.

The translucent panel 16 is preferably high impact rated, and designed to successfully pass Testing Application Standard 201-94 (TAS 201) based on a missile velocity of 35 miles per hour and Testing Application Standard 203-94 (TAS 203) based on a 9000-cycle regime applied consecutively. The translucent panel 16 preferably is a preassembled single or multiple (e.g., two) pane unit or cassette. An embodiment of panel 16 illustrated in FIG. 3 includes an inner pane composite on the interior side comprising first and second glass panes 16a, 16c and a polymeric layer 16b adhesively secured between the panes 16a, 16c. The polymeric layer 16b preferably is selected to provide controlled adhesion to glass and excellent impact resistance as part of a highly-penetration-resistant laminate panel. Polyvinyl butyral, such as Butacite® B56 of DuPont, is an example of a preferred polymer layer 16b material. By way of example, the polymer layer 16b may have a thickness of 0.060 inch to 0.125 inch, for example, 0.090 inch thickness. An opposing pane 16d is positioned on the interior side. It should be understood that pane 16d may be positioned on the exterior side, with the composite 16a-16c on the interior side. The panel 16 may comprise a peripheral rim surrounding the pane(s). In the case of a multiple pane unit, the peripheral rim may serve to seal the area between the panes. As referred to herein, the term translucent includes materials which permit light to pass through but diffuse the light so that persons, objects, etc. on the opposite side are not clearly visible, and also includes transparent materials which permit light to pass through with sufficiently small or no diffusion so that persons, objects, etc. on the opposite side are clearly visible. The panes 16a, 16c, 16d may be comprised of other materials known in the art, such as clear glass, annealed glass, tempered glass and various plastics. Additionally, the translucent panel 16 may be tinted or colored, or possess tinted or colored components, as may be desired. The translucent panel 16 may be designed in any configuration known in the art, and may also be installed as a side lite, a transom lite, or in a similar application.

In the illustrated embodiment, the first frame member 30 is disposed on the interior side of the translucent panel 16 and the associated door body 14, and the second frame member 50 is disposed opposite the first frame member 30 on the exterior side. The “interior” side or face of the door 12 refers to the portion of the door 12 which faces the inside of the building structure on which the door 12 is installed. The “exterior” side or face of the door 12 is opposite the interior side or face, and refers to the portion of the door 12 which faces away from the building structure on which the door 12 is installed. The exterior door skin of the door 12 is more exposed and subjected to the effects of weather than the interior door skin of the door 12.

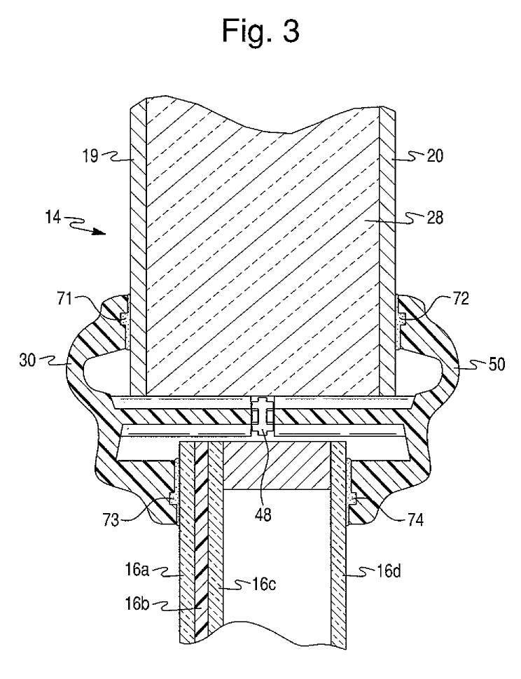

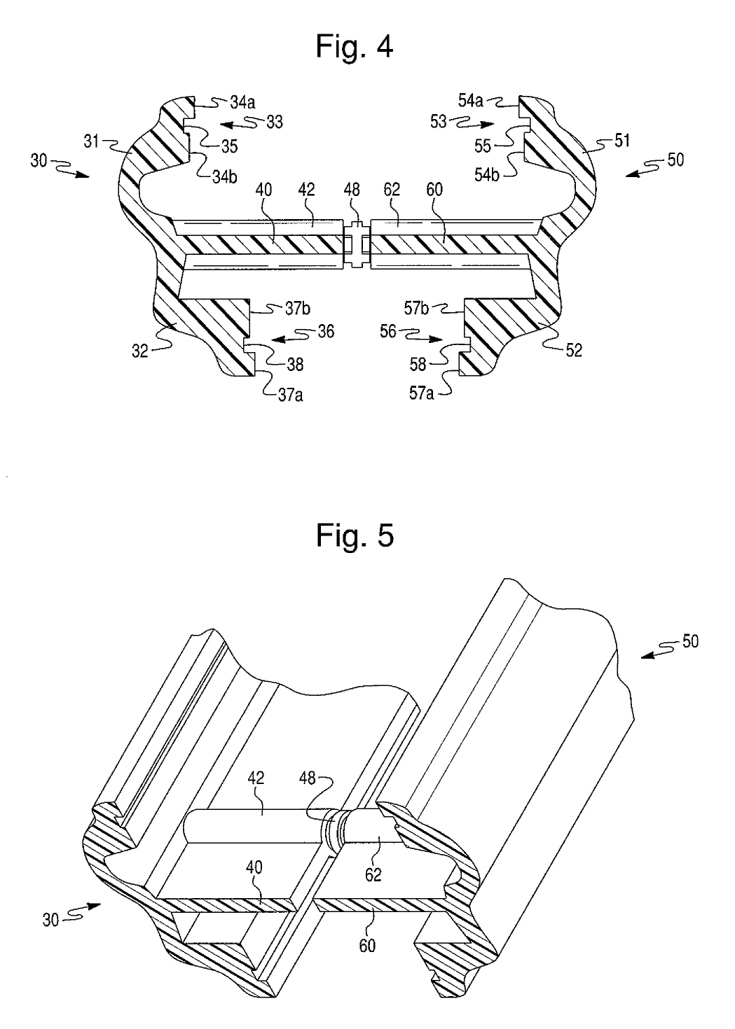

As best shown in FIGS. 4 and 5, the first frame member 30 includes a body portion comprised of a panel support portion 32 and a door receiving portion 31, which are integral with one another and collectively define a contoured, decorative outer surface. The panel support portion 32 terminates at a panel support lip 36, which includes two legs 37a, 37b and a sealant-receiving channel 38 interposed between the legs 37a, 37b. Leg 37a protrudes farther forward than leg 37b. The door receiving portion 31 likewise terminates at a door body receiving lip 33, which includes two legs 34a, 34b and a sealant-receiving channel 35 interposed between the legs 34a, 34b. Leg 34a protrudes farther forward than leg 34b. The first frame member 30 may be extruded through a die having the appropriate configuration.

The second frame member 50 is preferably the mirror image of the first frame member 30, and also preferably is extruded. Referring to FIG. 4, the second frame member 50 comprises a panel support portion 52, a door receiving portion 51, panel support lip 56 with legs 57a, 57b and sealant-receiving channel 58, and a door body receiving lip 53 with legs 54a, 54b and a sealant-receiving channel 55. Leg 57a protrudes farther forward than leg 57b, and leg 54a protrudes farther forward than leg 54b. It should be understood that frame members 30 and 50 are not necessarily mirror images of one another.

A reinforcing rib 40 extends from the body portion of the first frame member 30 towards a counterpart reinforcing rib 60 of the second frame member 50. Although depicted in the illustrated embodiment, it should be understood that ribs 40 and 60 are optional. The reinforcing ribs 40 and 60 include screw bosses 42, 62, respectively, sized to receive a frame connector (also referred to herein as a fastener) 48 for joining the first and second frame members 30, 50 to one another. Multiple screw bosses 42, 62 and frame connectors 48 preferably are situated at (uniform or non-uniform) spaced intervals around the frames 30, 50.

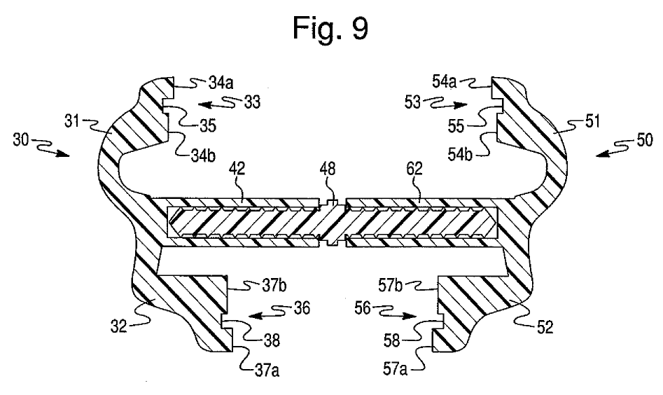

As best shown in FIG. 9, the illustrated connector 48 comprises shanks extending coaxially from opposite sides of a central flanged portion. The shanks have identical lengths to one another, and outer diameters approximately equal to the bore diameter of screw bosses 42 and 62, respectively, to permit insertion of the shanks into the bores of screw bosses 42 and 62, respectively, to provide a tight fit. The shanks may possess screw-threaded or serrated surfaces to facilitate their frictional retention in screw bosses 42, 62 and impede unintentional separation of the frame members 30, 50 from one another after the frame members have been set into place. The central flange portion of connector 48 is shown having a diameter greater than the bore diameter of screw bosses 42, 62, but less than or equal to the outer diameter of screw bosses 42, 62. During assembly the shanks of connector 48 are inserted into their respective screw bosses 42, 62 until the central flanged portion of connector 48 comes into contact with the ends of screw bosses 42, 62, thereby ensuring proper fit. Advantageously, in the illustrated embodiment, the frame connectors 48 are hidden from view. Consequently, the outer surfaces of the frame members 30, 50 are not obscured by unsightly screw holes or fasteners, and there is no need to plug or otherwise conceal exposed screw holes. Connector 48 may be made of, for example, metal (e.g., steel) or plastic. Alternative fasteners, such as screws, bolts, rivets, etc. may be used, as explored in more depth in connection with the second embodiment below.

The translucent panel 16 and the opening-defining boundary of the door body 14 are situated on opposite sides of the ribs 40, 60, as best shown in FIG. 3. The translucent panel 16 is positioned within, i.e., surrounded by, and supported by the frame members 30, 50. The frame members 30, 50 optionally are sized to snugly fit the outer edges of the translucent panel 16 against the inward facing surface of reinforcing ribs 40, 60, and more particularly the screw bosses 42, 62. Alternatively, the frame members 30, 50 may be designed to provide a gap between the outer edges of the translucent panel 16 and the screw bosses 42, 62. The frame members 30, 50 are in turn positioned within, i.e., surrounded by, the opening-defining boundary portion of the door body 14. The door opening 21, 22 optionally is sized to snugly fit the outward facing surface of reinforcing ribs 40, 60, and more particularly to place the screw bosses 42, 62 adjacent the opening-defining boundary of the door body 14. Although not shown, a gap may be provided between door openings 21, 22 and the screw bosses 42, 62, and optionally sealant or weatherproofing material may be placed between the door body 14 and the ribs 40, 60.

The first and second frame members 30 and 50 are comprised of a high impact plastic or plastics, preferably capable of injection molding. The high impact plastic optionally yet preferably has a minimum tensile strength of 7700 psi (ASTM D638) and a minimum notched Izod impact of 6 ft·lb/inch, more preferably 8 ft·lb/inch (ASTM D256). It is also preferred that the high impact plastic have a high UV resistance. Other preferred yet optional specifications for the high impact plastic include a self ignition temperature of greater than about 650° F. (ASTM D1929), a rate of burn of less than 2.5 inch/min (ASTM D635), a smoke density of less than 75% (ASTM D2843) and/or a tensile strength differential before/after 4500 hr xenon exposure of less than 10% (ASTM D638).

Particularly preferred are high-impact grade blends of polycarbonate and acrylonitrile styrene acrylate (ASA), such as Centrex 920® of Bayer Corporation and Geloy™ Resin XP4034 of General Electric Company. The frame members 30 and 50 may be manufactured using known injection molding and/or extrusion processes. Existing injection molding tooling may be used for injection molding the frame members 30, 50. Injection molding temperatures may range from 460° F. to 540° F., with mold temperatures of about 140-190° F. and an injection pressure of about 10,000 to about 20,000 psi. The particular processing conditions may depend on the polymer or polymer blend selected, and may vary outside of the ranges specified above.

The high impact plastic may be combined with various additives, including, by way of example and not necessarily limitation, reinforcing fibers (e.g., glass fibers) or particles, fillers, UV resistant compounds, flame retardants, pigments, and others.

The nominal cross sectional thickness of the walls of the frame members 30 and 50 is preferably about 0.125 inch. The frame members 30, 50 may have a height (from 34a to 37a), for example, of about 1.25 inch, and a width of about 1.25 inch. These dimensions may vary according to need or design. The length of the frame members 30, 50 will largely be dictated by the size of the door opening 21, 22.

The panel support portions 32, 52 of the first and second frame members 30, 50 laterally support the opposite surfaces of the translucent panel 16. In particular, lips 36 and 56 face the opposite surfaces of the translucent panel 16. Lips 36, 56 may directly contact the opposite surface of the translucent panel 16 or, as shown in FIG. 3, a thin layer of chemical sealant 73, 74 may be established between lips 36 and 56 and the opposite surfaces of translucent panel 16. In the illustrated embodiment, the leg 37a extends farther towards panel 16 than leg 37b, and leg 57a extends farther towards panel 16 than leg 57b. The chemical sealant and placement of lips 36, 56 relative to the opposite surfaces of the translucent panel 16 creates a seal that assists in the prevention of moisture or precipitation, such as rain, sleet or snow, from entering into the door lite frame.

As best shown in FIG. 3, chemical sealant 73 and 74 is situated at the interface of leg 37a and glass pane 16a, and the interface of leg 57a and opposing pane 16d, respectively, to establish a weather-tight seal between the frame members 30, 50 and the translucent panel 16. Additionally or alternatively, chemical sealant 73 and 74 may be disposed within channels 38 and 58 and on legs 37b and 57b for improving the seal further. The sealant may be applied elsewhere to improve the seal between the lips 36 and 56 and translucent panel 16. For example, the sealant may be applied at the interface of the outer surface of the panel support portions 32, 52 and the opposite sides of the translucent panel 16.

The sealant also serves to establish a water-proof seal between the door body 14 and the frame members 30, 50. The door body receiving portions 31, 51 of the first and second frame members 30, 50 are situated at opposite surfaces of the door body 14. The lips 33 and 53 may directly contact the opposite surfaces of the door body 14, or, as shown in FIG. 3, a thin layer of chemical sealant 71 and 72 may be established between lips 33 and 53 and the first and second door skins 19, 20. In the illustrated embodiment the leg 34a extends farther towards the door body 14 than leg 34b, and leg 54a extends farther towards the door body 14 than leg 54b. The chemical sealant 71, 72 between legs 34a, 54a and the opposite surfaces of the door body 14 establishes a firm seal. Additionally or alternatively, sealant 71 and 72 may be disposed within channels 35, 55 of lips 33, 53 and on legs 34b, 54b for improving the seal further. The sealant may also or alternatively be applied elsewhere to improve the seal between the lips 33, 53 and the door body 14. For example, the sealant may be applied at the interface of the outer surface of the lips 33, 53 and the interfacing surfaces of the opposite sides of the door body 14.

The sealant 71, 72 disposed between the door body 14 and the frame members 30, 50 may be identical to or different from the sealant 73, 74 disposed between the translucent panel 16 and the frame members 30, 50. Similarly, the sealant 71 may be the same or different than sealant 72, and the sealant 73 may be the same or different than sealant 74. The sealant 71-74 is preferably sufficiently flexible to allow for some give during pressure and vacuum differentials between opposites sides of the resulting door body 14, such as may occur during certain hurricane conditions. The sealant preferably has a Shore A Durometer Hardness of less than 40 points, more preferably about 35 points or less, and an elongation of about 500% or less, more preferably about 450% or less. In a preferred embodiment, the sealant is a silicone sealant, such as Dow Corning® 832 multi-surface silicone sealant. The sealant is sufficiently flexible to allow for some movement between panel 16 and frame members 30, 50 while also providing a weather-tight seal between panel 16 and frame members 30, 50.

The sealant prevents water from migrating into the panel 16 and also prevents rattling of the panel 16 against the frame members 30, 50 as might otherwise occur, while being sufficiently flexible to allow for some movement between panel 16 and frame members 30, 50. The sealant acts in conjunction with the high impact-resistant frame members 30, 50 and the high-impact resistant translucent panel 16, and in particular the polymeric interlayer of the panel 16, to establish an effective barrier and energy absorber against high winds and projectile objects propelled by the winds. Further, the high impact plastic of frame members 30, 50 serves to provide improved temperature insulation.

While a non-structural sealant is preferred, a structural sealant may be suitable for some applications requiring less flexibility between panel 16 and frame members 30, 50. For example, a sealant having a Shore A Durometer Hardness of 40 points or more, and an elongation of 500% or more, may be used for some applications. For example, a structural silicone sealant, such as Dow Corning® 995 silicone structural sealant or Proglaze® of Tremco, Inc., may be used. Structural adhesives also may be used.

It should be understood that the frame structure may be composed of fewer or more members than described in the illustrated embodiment. Also, the door 12 may contain multiple door lites.

An embodiment of a method for assembling the door 12 with the translucent panel is described in detail below, mostly with reference to FIG. 2. It should be understood that alternative and modified methods may be employed for manufacturing the door 12 and the door lite-frame assembly of the present invention.

The first and second door skins 19 and 20 are purchased, manufactured, or otherwise obtained for the purposes of this method. Compression molding is an example of a well known manufacturing method suitable for making the door skins 19 and 20, especially contoured door skins. Alternatively, the door skins may have a flat planar surface. Suitable door skin materials include polymers, composites, and other materials known in the art, and include, for example, fiber glass reinforced SMC, mats of cellulosic materials and binder, and steel sheets. The skin materials may contain additives and reinforcements, such as impregnated mats and fabrics. The openings 21 and 22 are preferably molded into the door skins 19 and 20, respectively, during manufacture in order to reduce material cost and minimize manufacturing costs. Alternatively, openings 21 and 22 may be created subsequent to molding and injection of the expandable foam core 28. As is known in the art, the mold dies may have surfaces with configurations capable of molding various shapes and patterns into the door skins 19 and 20. For example, the mold dies may possess depressions and protrusions for forming internal panels, or high level detail imitating wood grain. Although the embodied door has been illustrated as a foam-filled door, it should be understood that other door body structures, including solid integral structures (e.g., a solid wood door), may be selected within the scope of the invention.

Then, the first and second door skins 19 and 20, the top and bottom rails 17, and left and right stiles 18 are aligned and attached to each other with adhesive and/or fasteners. The cavity 34 established between the first and second door skins 19 and 20 is then filled with an expandable material, such as a polyurethane or other foamable material, which foams into a core 28 that preferably adds discernable weight to the door 12 so that the door has the feel of a solid wood object. The core 28 also preferably provides sound and thermal insulation properties. Optionally, the step of filling the cavity with the expandable foam material 28 is performed while the semi-assembled door 12 is held in an appropriate press (not shown). The semi-assembled door 12 is placed into the press to hold the skins 19, 20 into engagement with the rails 17 and stiles 18. The press platens may be heated to enhance curing of the adhesive bonding of the rails 17 and stiles 18 to the door skins 19, 20. Expansion of the insulating foam may be by exothermic reaction, so alternatively the press platens may be cooled to remove the heat of expansion attributable to the foaming. The press platens have sufficient strength to prevent deflection of the planar surface portions of the door skins 19, 20 during the foaming operation. The door 12 is then removed from the press. Alternatively, a prefabricated core may be placed between the door skins 19, 20 prior to assembly.

Thereafter, the translucent panel 16 is inserted into the openings 21, 22 in the first and second door skins 19, 20. Because the openings 21, 22 are larger in width and height than the corresponding dimensions of the translucent panel 16, a relatively uniform gap should be established between the outer periphery of the translucent panel 16 and the opening-defining boundaries of the door skins 19, 20.

The frame members 30 and 50 may be formed by injection molding, extruding, or otherwise processing an appropriate polymer material as a continuous body. The ability to prepare the frame members 30, 50 using existing injection molding apparatus and tools is a highly beneficial advantage of the preferred embodiment of the invention. Capital expenditures and expenses are lowered in this manner. The continuous body may then be cut to length and mitered to provide the individual frame members 30 and 50. The frame members 30, 50 may be connected using known techniques, such as welded corner joints or mechanical fasteners.

In an implementation of the method, the frame connectors 48 are placed into the screw bosses 42 of the first frame member 30, and sealant 71, 73 is placed on legs 34a, 37a and/or into the channels 35, 38 and on legs 34b, 37b of the first frame member 30. The first frame member 30 is then inserted into the uniform gap from the first side of the door body 14 and the translucent panel 16. Sealant 72, 74 is placed on legs 54a, 57a and/or into channels 55, 58 and on legs 54b, 57b of the second frame member 30, and the second frame member 50 is inserted into the uniform gap from the opposite second side of the door body 14 and the translucent panel 16. The first and second frame members are aligned with one another so that the frame connectors 48 partly received in the screw bosses 42 are received within the screw bosses 62 of the second frame member 50. The frame members 30 and 50 are pressed together to create a tight seal between legs 37a, 57a and the opposite sides of the translucent panel 16, and between legs 34a, 54a and the opposite sides of the door body 14.

It should be understood that the sequence of steps described above for making door 12 is not necessarily limiting, and that alternative sequences may be employed. For example, the openings 21, 22 of the door skins 19, 20 may be cut after the door skins have been thermoformed and the core foamed. Also, additional or fewer steps than described above may be practiced in making the door lite structure and the door.

While it is preferred that the door 12 be removed from the press and stocked in inventory, so that the appropriate frame members 30, 50 and translucent panel 16 may be installed as ordered by consumers, those skilled in the art will recognize that the frame members 30, 50 and the translucent panel 16 may be installed prior to or after the door 12 is held between the press platens.

Referring now more particularly to the second embodiment illustrated in FIGS. 6 and 7, there is illustrated a patio door 112 including a door body 114 with a rectangular opening for receiving translucent panel 116, such as impact-rated glass. First and second frame member 130, 150 (FIG. 7) interconnect the door body 114 to the translucent panel 116. The door 112 may be for residential, business, or industrial use. Although illustrated as a patio door, door 112 may be a main exterior door with or without a panel design, similar to door 12 shown in FIG. 1.

Generally, the construction and method of assembly of door 112 is substantially identical to the description above regarding door 12. In the interest of brevity, the following discussion will focus on differences between the doors 112 and 12. Otherwise, the description above regarding the door 12 is applicable to door 112, and is incorporated herein by reference.

The first frame member 130 is disposed on the exterior side of the translucent panel 116 and the associated door body 114, and the second frame member 150 is disposed opposite the first frame member 130 on the interior side. The “interior” side or face of the door 112 refers to the portion of the door 112 which faces the inside of the building structure on which the door 112 is installed. The “exterior” side or face of the door 112 is opposite the interior side or face, and refers to the portion of the door 112 which faces away from the building structure on which the door 112 is installed.

Panel support portions 132, 152 of the first and second frame members 130, 150 laterally support the opposite surfaces of the translucent panel 116. In particular, panel support portions 132 and 152 terminate at lips 136 and 156, which face the opposite surfaces of the translucent panel 116. A thin layer of chemical sealant may be situated at the interfaces of lips 136, 156 and the opposite surfaces of translucent panel 116. Due to the intimate contact of the lips 136 and 156 and/or chemical sealant against the opposite surfaces of translucent panel 116, a seal is created that assists in the prevention of moisture or precipitation, such as rain, sleet or snow, in the translucent panel 116.

The door body receiving portions 131, 151 of the first and second frame members 130, 150 are situated on opposite surfaces of the door body 114. Door receiving portions 131 and 151 terminate at door body receiving lips 133 and 153, respectively, which face the opposite sides of the door body 114. A thin layer of chemical sealant may be situated at the interface of lips 133, 153 and the opposite sides of the door body 114.

The primary difference between the frame members 30, 50 of the first embodiment and the frame member 130, 150 of the second embodiment resides in the screw bosses 142, 162 and the connector (not shown). The screw boss 142 and 162 possess first and second screw-receiving channels 144 and 164, respectively, which are coaxially aligned with one another. Generally, the first screw-receiving channel 144 tapers and is smaller in diameter than the second screw-receiving channel 164. Further, the first screw-receiving channel 144 is not exposed at the exterior surface of frame member 130, whereas the second screw-receiving channel 164 contains an exposed opening in which a connector, such as a screw, is inserted along direction A.

To assemble the door 112, the translucent panel 116 is inserted into the opening of the door body 114. Because the opening is larger in width and height than the corresponding dimensions of the translucent panel 116, a relatively uniform gap should be established between .the outer periphery of the translucent panel 116 and the opening-defining boundaries of the door body 114. Sealant is placed on lips 133, 136 of the first frame member 130, and the first frame member 130 is then inserted into the uniform gap from the exterior side of the door body 114 and the translucent panel 116. The sealant is placed on lips 153, 156 of the second frame member 150, and the second frame member 150 is inserted into the uniform gap from the interior side of the door body 114 and the translucent panel 116. The first and second frame members 130, 150 are positioned relative to one another so that the screw bosses 142 and 162 are aligned with one another. The frame members 130 and 150 are pressed together to create a tight seal between lips 136, 156 and the opposite sides of the translucent panel 116, and between lips 133 and 153 and the opposite sides of the door body 114. A screw is inserted into the exposed opening of the second screw-receiving channel 164, driven into the first screw-receiving channel 144, and tightened to secure the frame members 130, 150 to one another.

From the foregoing description it is clear that the current invention describes an inventive hurricane door light that passes the TAS 201 and TAS 203 tests, and is easy to manufacture and install. The invention may be modified in multiple ways and applied in various technological applications. It is understood that while various preferred designs have been used to describe this invention, the invention is not limited to the illustrated and described features.

Modifications, usages and/or adaptations following the general principles disclosed herein are included in the present invention, including such departures that come within known or customary practice in the art to which this invention pertains. The present invention is intended to encompass all such departures having the central features set forth above, without departing from the scope and spirit of the invention, and which fall within the scope of the appended claims.

What is claimed is:

1. A door lite assembly, comprising:
a translucent panel having a periphery and opposite first and second sides;
a high-impact plastic frame extending along the periphery of the translucent panel and comprising
first and second panel support portions having first and second panel support lips facing the first and second sides of the translucent panel, respectively; and
first and second door receiving portions having first and second door body receiving lips, respectively, spaced apart from one another to permit receipt of a door body between the first and second door body receiving lips; and
a chemical sealant establishing a water-proof seal between the first and second panel supporting lips and the translucent panel, wherein the high-impact plastic frame, translucent panel and the sealant establish a structure capable of withstanding the effects of certain hurricane conditions as measured by successful passing of Testing Application Standard 201-94 (TAS 201) based on a missile velocity of 35 miles per hour and Testing Application Standard 203-94 (TAS 203) based on a 9000-cycle regime applied consecutively.

2. The door lite assembly of claim 1, wherein the frame comprises a blend comprising polycarbonate and an acrylonitrile-styrene-acrylate terpolymer.

3. The door lite assembly of claim 1, wherein the chemical sealant comprises an organosiloxane.

4. The door lite assembly of claim 1, wherein the high-impact plastic frame has a minimum tensile strength of 7700 psi and a minimum Notched Izod Impact of 6 ft·lb/inch.

5. The door lite assembly of claim 1, wherein the chemical sealant has a Shore A Durometer Hardness of less than 40 points.

6. The door lite assembly of claim 1, wherein the translucent panel comprises a laminate comprising first and second panes and a polymeric interlayer interposed between the first and second panes for improving impact performance of the translucent panel.

7. The door lite assembly of claim 1, wherein:
the high-impact plastic frame comprises a first frame member, a second frame member, and a frame connector securing the first and second frame members together, the first frame member comprising the first panel support portion and the first door receiving portion, the second frame member comprising the second panel support portion and the second door receiving portion.

8. The door lite assembly of claim 7, wherein the frame connectors are hidden from outside view.

9. The door lite assembly of claim 8, wherein the frame connectors comprise a central flange portion and first and second shanks extending outwardly from the central flange portion, the first and second shanks being received in respective screw bosses of the first and second frame members.

10. A door, comprising:
a door body having first and second sides and an opening;
a translucent panel situated in the opening, the panel having a periphery and opposite first and second sides;
a high-impact plastic frame extending along the periphery of the translucent panel and an opening-defining boundary of the door body, the frame comprising
first and second panel support portions having first and second panel support lips facing the first and second sides of the translucent panel, respectively; and
first and second door receiving portions having first and second door body receiving lips facing the first and second sides of the door body, respectively; and
a chemical sealant establishing a first water-proof seal between the first and second panel supporting lips and the translucent panel, and to establish a second water-proof seal between the first and second body receiving lips and the door body, wherein the door body, translucent panel, high-impact plastic frame and the sealant establish a structure capable of withstanding the effects of certain hurricane conditions as measured by successful passing of Testing Application Standard 201-94 (TAS 201) based on a missile velocity of 35 miles per hour and Testing Application Standard 203-94 (TAS 203) based on a 9000-cycle regime applied consecutively.

11. The door of claim 10, wherein the frame comprises a blend comprising polycarbonate and an acrylonitrile-styrene-acrylate terpolymer.

12. The door of claim 10, wherein the chemical sealant comprises an organosiloxane.

13. The door of claim 10, wherein the high-impact plastic frame has a minimum tensile strength of 7700 psi and a minimum Notched Izod Impact of 6 ft·lb/inch.

14. The door of claim 10, wherein the chemical sealant has a Shore A Durometer Hardness of less than 40 points.

15. The door of claim 10, wherein the translucent panel comprises a laminate comprising first and second panes and a polymeric interlayer interposed between the first and second panes for improving impact performance of the translucent panel.

16. The door of claim 10, wherein:
the high-impact plastic frame comprises a first frame member, a second frame member, and a frame connector securing the first and second frame members together, the first frame member comprising the first panel support portion and the first door receiving portion, the second frame member comprising the second panel support portion and the second door receiving portion.

17. The door of claim 16, wherein the frame connectors are hidden from outside view.

18. The door of claim 17, wherein the frame connectors comprise a central flange portion and first and second shanks extending outwardly from the central flange portion, the first and second shanks being received in respective screw bosses of the first and second frame members.

19. A method of making a door lite assembly, comprising:
providing a translucent panel having a periphery and opposite first and second sides;
applying a high-impact plastic frame extending along the periphery of the translucent panel and comprising
first and second panel support portions having first and second panel support lips facing the first and second sides of the translucent panel, respectively; and
first and second door receiving portions having first and second door body receiving lips, respectively, spaced apart from one another to permit receipt of a door body between the first and second door body receiving lips; and
applying a chemical sealant to establish a water-proof seal between the first and second panel supporting lips and the translucent panel, wherein the high-impact plastic frame, translucent panel and the sealant establish a structure capable of withstanding the effects of certain hurricane conditions as measured by successful passing of Testing Application Standard 201-94 (TAS 201) based on a missile velocity of 35 miles per hour and Testing Application Standard 203-94 (TAS 203) based on a 9000-cycle regime applied consecutively.

20. The method of claim 19, wherein the frame comprises a blend comprising polycarbonate and an acrylonitrile-styrene-acrylate terpolymer.

21. The method of claim 19, wherein the chemical sealant comprises an organosiloxane.

22. The method of claim 19, wherein the high-impact plastic frame has a minimum tensile strength of 7700 psi and a minimum Notched Izod Impact of 6 ft·lb/inch.

23. The method of claim 19, wherein the chemical sealant has a Shore A Durometer Hardness of less than 40 points.

24. The method of claim 19, wherein the translucent panel comprises a laminate comprising first and second panes and a polymeric interlayer interposed between the first and second panes for improving impact performance of the translucent panel.

25. The method of claim 19, wherein:
the high-impact plastic frame comprises a first frame member, a second frame member, and a connector securing the first and second frame members together, the first frame member comprising the first panel support portion and the first door receiving portion, the second frame member comprising the second panel support portion and the second door receiving portion.

26. The method of claim 25, wherein the frame connectors are hidden from outside view.

27. The method of claim 26, wherein the frame connectors comprise a central flange portion and first and second shanks extending outwardly from the central flange portion, the first and second shanks being received in respective screw bosses of the first and second frame members.

28. A method of making a door, comprising:
providing a door body having first and second sides and an opening;
situating a translucent panel in the opening, the panel having a periphery and opposite first and second sides;
applying a high-impact plastic frame extending along the periphery of the translucent panel and comprising
first and second panel support portions having first and second panel support lips facing the first and second sides of the translucent panel, respectively; and
first and second door receiving portions having first and second door body receiving lips facing the first and second sides of the door body, respectively; and
applying a chemical sealant to establish a first water-proof seal between the first and second panel supporting lips and the translucent panel, and to establish a second water-proof seal between the first and second body receiving lips and the door body, wherein the door body, translucent panel, high-impact plastic frame and the sealant establish a structure capable of withstanding the effects of certain hurricane conditions as measured by successful passing of Testing Application Standard 201-94 (TAS 201) based on a missile velocity of 35 miles per hour and Testing Application Standard 203-94 (TAS 203) based on a 9000-cycle regime applied consecutively.

29. The method of claim 28, wherein the frame comprises a blend comprising polycarbonate and an acrylonitrile-styrene-acrylate terpolymer.

30. The method of claim 28, wherein the chemical sealant comprises an organosiloxane.

31. The method of claim 28, wherein the high-impact plastic frame has a minimum tensile strength of 7700 psi and a minimum Notched Izod Impact of 6 ft·lb/inch.

32. The method of claim 28, wherein the chemical sealant has a Shore A Durometer Hardness of less than 40 points.

33. The method of claim 28, wherein the translucent panel comprises a laminate comprising first and second panes and a polymeric interlayer interposed between the first and second panes for improving impact performance of the translucent panel.

34. The method of claim 28, wherein:
the high-impact plastic frame comprises a first frame member, a second frame member, and a connector securing the first and second frame members together, the first frame member comprising the first panel support portion and the first door receiving portion, the second frame member comprising the second panel support portion and the second door receiving portion.

35. The method of claim 34, wherein the frame connectors are hidden from outside view.

36. The method of claim 35, wherein the frame connectors comprise a central flange portion and first and second shanks extending outwardly from the central flange portion, the first and second shanks being received in respective screw bosses of the first and second frame members.
